(19) United States
(12) Patent Application Publication
(10) Pub. No.: US 2003/0159355 A1
(43) Pub. Date: Aug. 28, 2003

(54) Multiple louver control system

(76) Inventors: Dave Froerer, Costa Mesa, CA (US); Gary Skinner, Westminster, CO (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/090,566

(22) Filed: Feb. 28, 2002

(51) Int. Cl. E06B 3/48

(52) U.S. Cl. 49/74.1; 49/73.1

(57) ABSTRACT

An automatic louver actuating system includes a plurality of louvered panels that are each made up of a plurality of louvers capable of rotational movement. The system also includes a plurality of motors that control the rotational movement of each plurality of louvers. A control module communicates the desired position of the louvers to each motor.

### BACKGROUND OF THE INVENTION

1. Field of the Invention

The present invention relates generally to louver mechanisms and, in particular, to the control of multiple louvered panels through enclosed louver mechanisms.

Various louver mechanisms have been developed to simultaneously actuate a louvered panel or other window coverings such as shutters located within, adjacent to, or around a window frame. These mechanisms include tilt rods or other such actuating members, which are external of the louvers of the louvered panels. These mechanisms actuate the louvers. These mechanisms allow for the opening and closing of the louvers but are not aesthetically pleasing since the mechanism is visible.

Some of the louvered panel designs do not include a tilt rod. These designs are instead configured so that any adjustment of one louver causes a like adjustment to the remaining louvers in a panel. These mechanisms, however, require physical manipulation of one louver in order to move the others. These designs, however, can limit the range of motion for the louvers such that a full rotation for each louver (ideally 180°) is not possible. This limited range of motion is partially due to the presence of a hand on the actual louvers. A full 180 degrees of rotation is desirable to provide all possible choices of light transmission through the louvered panel at any given partially open position.

Additionally, there is a need for electronic control of the louvers, and particularly, multiple louvered panels. It is often time consuming to physically manipulate the louvers to get the exact position desired for the louvers. Also, physical manipulation may stain or even cause damage to the louvers if too much force is used. Likewise, some louvers and louvered panels may be out of reach for physical manipulation. Thus, an electronic control system is desirable.

An electronic control system, however, must be practical. An electronic control for one louvered panel may be located on or adjacent to the louvered panel with which the control is associated. In such instances, a user must be present at the louvered panel to control the louvers of that louvered panel. The requirement of physical presence of the user at the location of the louvered panel becomes more inconvenient when several electronically controlled louvered panels need to be adjusted. In such instances, a user must walk from louvered panel to louvered panel to use each louvered panel's electronic control. This would be time consuming. Thus, there is a need for a remote electronic control of a plurality of louvered panels.

### SUMMARY OF THE INVENTION

An automatic louver actuating system includes a plurality of louvered panels that are each made up of a plurality of louvers capable of rotational movement. The system also includes a plurality of motors that control the rotational movement of each plurality of louvers. A control module communicates the desired position of the louvers to each motor.

A method of electronic louver actuating includes communicating to a first motor a first desired position for a first set of louvers in a first louvered panel and communicating to a second motor a second desired position for a second set of louvers in a second louvered panel. Additionally, the first set of louvers are rotated to the first desired position by the first motor, while the second set of louvers are rotated to the second desired position by the second motor. The first and second desired positions may be at the same or different angles with respect to the horizontal.

An electronic louver actuating system includes a plurality of frames that define an interior region. A plurality of slats are rotatably disposed within each interior region of the plurality of frames. A plurality of electronic actuating devices are capable of rotating the plurality of slats within each of the plurality of frames. Also, a control module communicates with each electronic actuating device.

### BRIEF DESCRIPTION OF THE DRAWINGS

FIG. 1 is a front elevational view of a louver panel according to one embodiment of the present invention.

FIG. 2 is a front elevational, partial cutaway view of a louver panel according to one embodiment of the present invention.

FIG. 3A is a schematic view of the control system for use in one embodiment of the present invention.

FIG. 3B is a partial side elevational view of a remote control for use in one embodiment of the present invention.

FIG. 3C is a front elevational view of a plurality of louvered panels.

FIG. 4 is a perspective view depicting the assembly of a louver mechanism for actuating the louvers of a louvered panel.

FIG. 5A is a view of the gear track segment of the pin mechanism shown in FIG. 4.

FIG. 5B is another view of the gear track segment of the pin mechanism shown in FIG. 4.

FIG. 6 is a partial side elevation view of the plurality of louvers shown in FIG. 1.

FIG. 7 is a partial side elevational view of the plurality of louvers shown in FIG. 1.

### DETAILED DESCRIPTION OF THE PREFERRED EMBODIMENTS

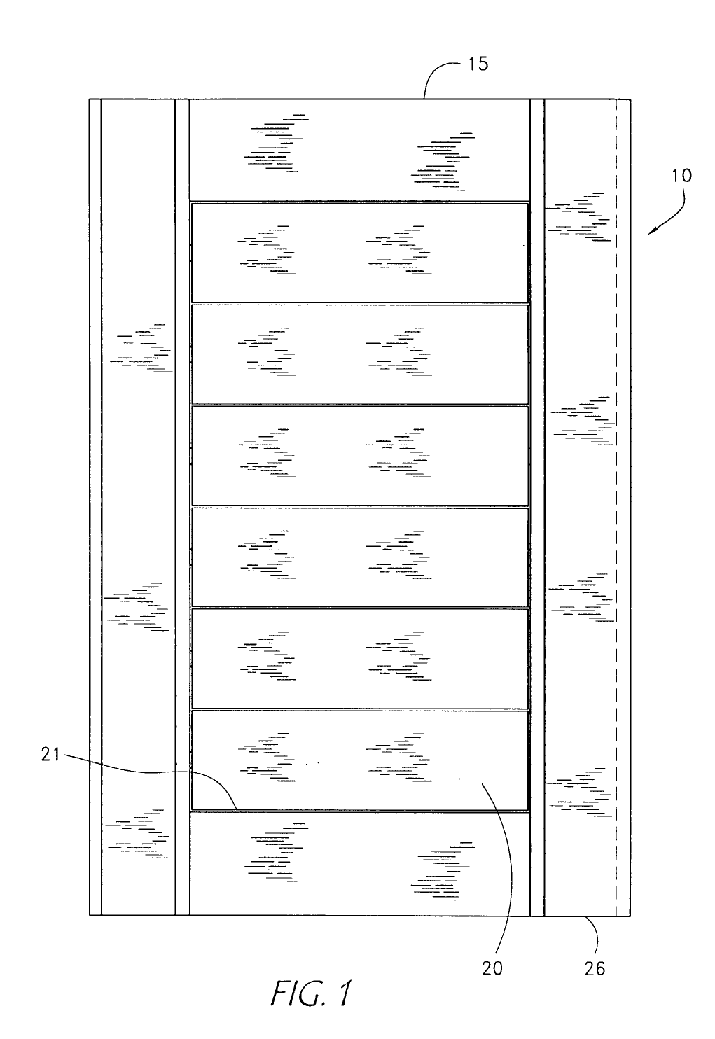

Referring now to FIG. 1, a louvered panel 10 is shown including a general frame 15 and a plurality of louvers 20 rotationally mounted therein. The frame 15 may include different types of styles and constructions for the vertical and horizontal parts of the frame. In the preferred embodiment, the frame 15 is constructed of wood and employs generally a tongue-and-groove construction held together by a combination of adhesives and fasteners. Other materials and constructions known to those of skill in the art are also contemplated and readily ascertainable by those of skill in the art. For example, frame 15 can be constructed of aluminum and employ fasteners to connect its various components.

Preferably louvers 20 (also called slats) are adapted for placement adjacent to or in connection with like louvers 20. For example, as shown in FIG. 1, all the louvers 20 are in the a vertical position. This position is also referred to as a “closed” position. Essentially, the position is where all the louvers 20 are vertical. Whether they are considered up or down is relative to the points considered as the 0 degree and 180 degree locations. In the preferred embodiment, tip 21 of a louver 20 rotated toward the bottom of the louvered panel is considered at the 0 degree location. Likewise, if tip 21 of a louver 20 is oriented toward the top of the louvered panel, that louver would be considered at the 180 degree location. With the louvers vertical, substantially no light from outside can penetrate the window louvered panel 10. This position of louvers 20 when vertical can also be described as fully up or fully down. Fully up or fully down refers to the fact that in this position the tips of the louvers 20 are either rotated towards the top or bottom of the louvered panel 10.

The louvers 20 can also be arranged so that the top of one louver 20 overlaps with the bottom of another louver 20 above it, when they are rotated toward the top of the panel. In such an arrangement, the bottom of one louver 20 overlaps with the top of another louver 20 below it, when they are rotated toward the bottom of the panel. In this situation, the louvers 20 will not have a full 180° degrees of rotation. Instead, the louvers 20 will have a rotation from about 5° to 175°.

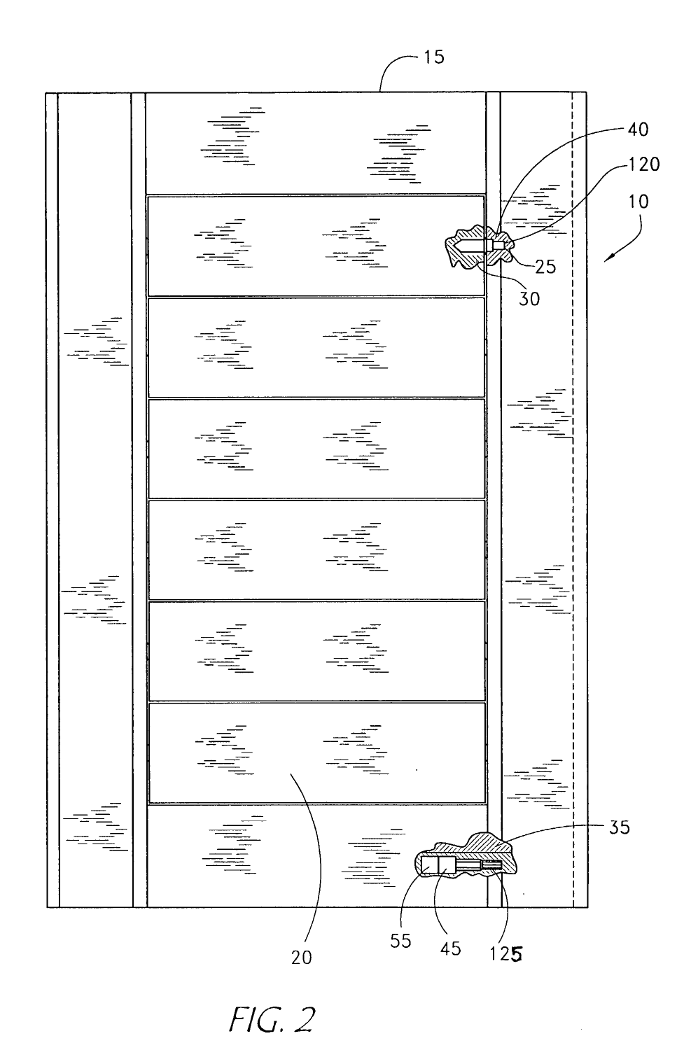

Referring now to FIG. 2, a louver panel 10 is shown including cut-outs of the louver drive mechanism 35 and louver pin mechanism 40. The louver drive mechanism 35 includes a motor system 45 and a motor pinion 125 for receiving a rack mechanism (not shown). The louver drive mechanism 35 is preferably driven by a motor system 45 and a motor control module 55. The motor system 45 can be one available from MicroMo Electronics, Inc (Clearwater, Fla.). The motor control module 55 can be one available from Electronic Solutions, Inc. (Broomfield, Colo.). The louver mechanism 35 also has the capability to receive data or control information from a system control module (not shown).

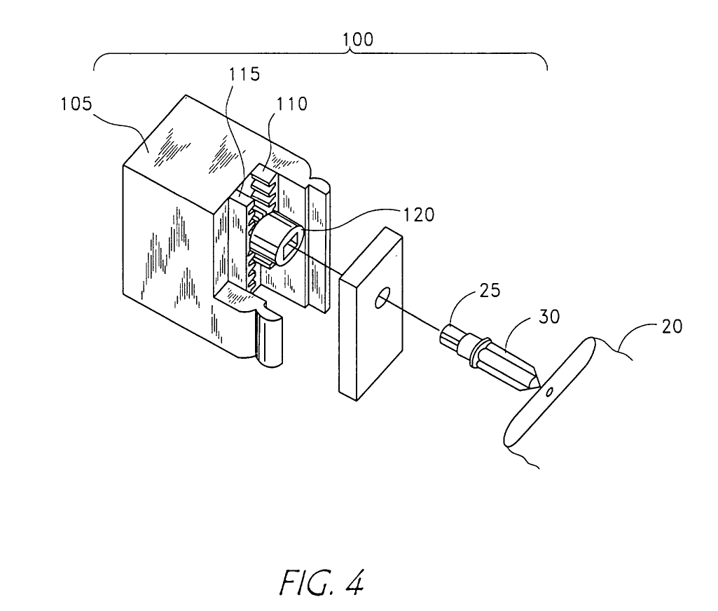

The louver drive mechanism 35 can be located at the bottom or top of the louvered panel 10. Likewise, the louver drive mechanism 35 can be located at the right or left of the louvered panel 10. Furthermore, the louver drive mechanism 35 can be positioned to have its motor system 45 and motor control module 55 toward the outside of the frame 15 (as shown in FIG. 2), or toward the inside of the frame 15 (the mirror of what is shown in FIG. 2). In any of these possible configurations, the motor pinion 125 should engage the racks 110, 115 (shown in FIG. 4). The racks 110, 115 (shown in FIG. 4) run from the motor pinion 125 through the pinion 120 of the pin mechanism 40 of each louver 20. The pin mechanism 40 includes a pinion engagement piece 25 and louver pin 30 which both rotate as the pinion 120 rotates. The pinion 120 rotates with the rotation of the motor pinion 125 through the mechanism of the rack system. As is known to those of skill in the art, any combination or permutation of these variables is possible. The rotation of the motor pinion 125 occurs with activation of the motor system 45, which is controlled by the motor control module 55.

As used herein, the word module, whether in upper or lower case letters, refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. A module may be a single unit or a unit with multiple parts.

Referring to FIG. 2, the motor control module 55 of the louver drive mechanism 35 may be external to the louvered panel 10 or internal. The system control module (not shown) can communicate with the louver drive mechanism 35 to relay information and/or data that informs the louver drive mechanism 35 the desired position of the louvers 20. This information may include, but is not limited to, the desired position of the louvers 20 and how fast to run the motor to achieve that desired position. A variety of communications protocols, such as serial communications, RS-232 standard interface, field bus and TCP/IP for the communication of such information is known to those of skill in the art.

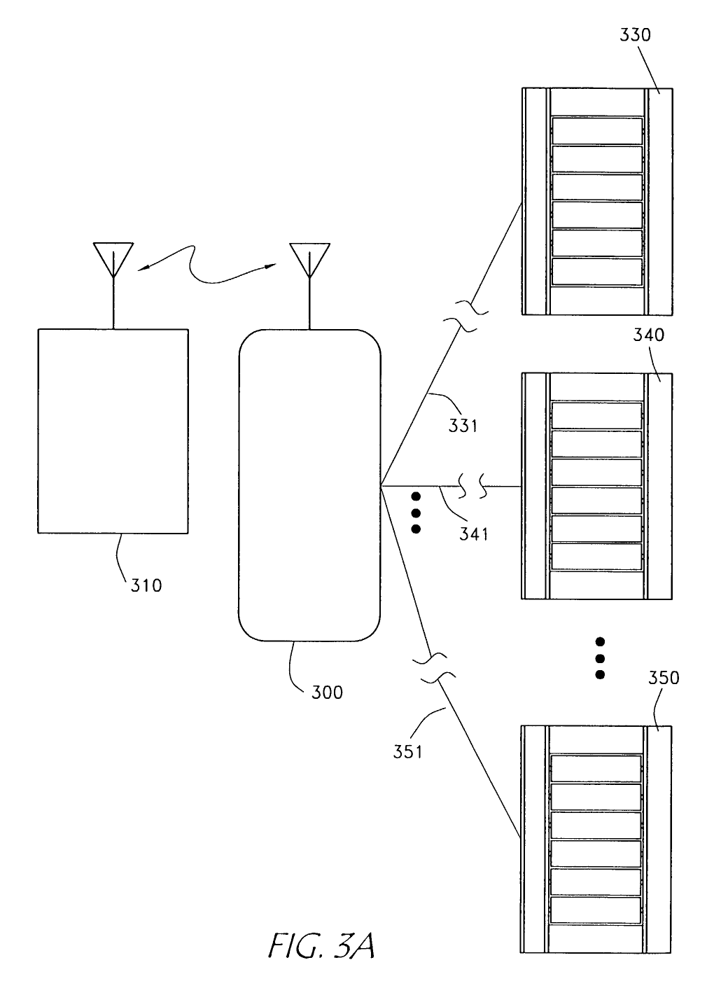

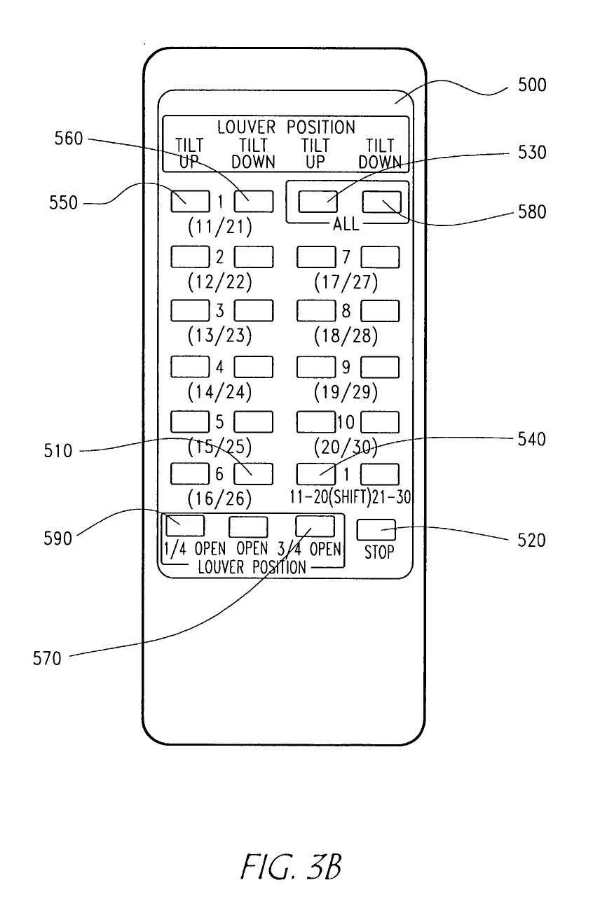

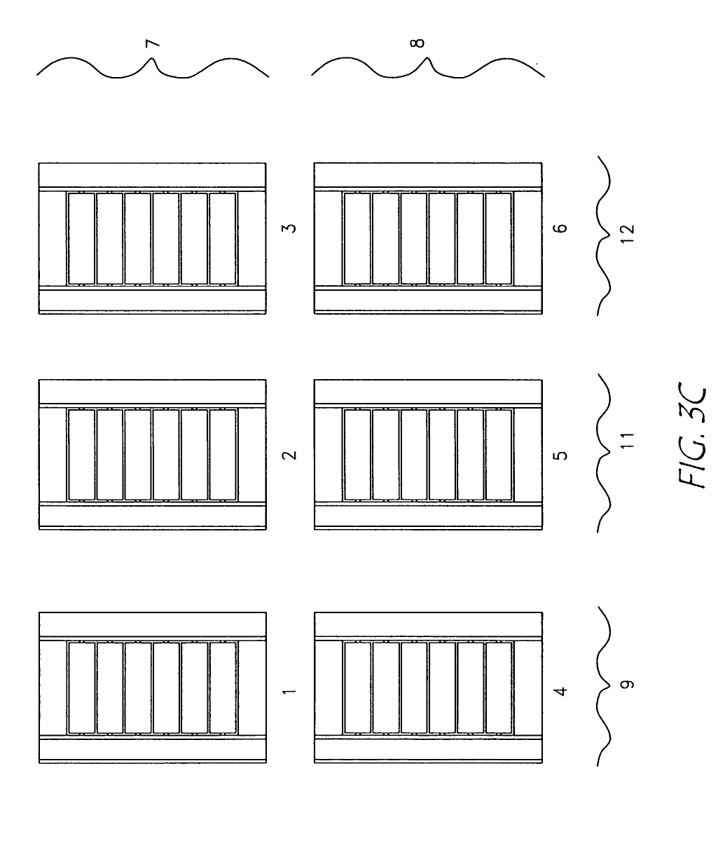

With reference to FIG. 3A, a schematic view of the control system for use in one embodiment of the present invention is shown. A remote control module 310 is capable of communicating with a system control module 300. The communication medium between the remote control module 310 and the system control module 300 is preferably wirless, such as light including but not limited to infrared, radio, ultrasonic or cellular. Preferably, a user operates the remote control module 310 to instruct the system control module 300 of actions to perform. Alternatively, other communications are possible such as hardwires and the like. The remote control module 310 can be mounted to a wall and have either wireless or hardwire communications.

Focusing now on the communication medium, a communication medium can also include the Internet which is a global network of computers. In this embodiment, the communication from the remote 310 to the system control module 300 is achieved over the internet, by way of a variety of ways known in the art. The structure of the Internet, which is well known to those of ordinary skill in the art, includes a network backbone with networks branching from the backbone. These branches, in turn, have networks branching from them, and so on. Routers move information packets between network levels, and then from network to network, until the packet reaches the neighborhood of its destination. From the destination, the destination network's host directs the information packet to the appropriate terminal, or node. For a more detailed description of the structure and operation of the Internet, please refer to “The Internet Complete Reference,” by Harley Hahn and Rick Stout, published by McGraw-Hill, 1994.

In one advantageous embodiment, the Internet routing hubs comprise domain name system (DNS) servers. DNS is a Transfer Control Protocol/Internet protocol (TCP/IP) service that is called upon to translate domain names to and from Internet Protocol (IP) addresses. The routing hubs connect to one or more other routing hubs via high speed communication links.

One of ordinary skill in the art, however, will recognize that a wide range of interactive communication mediums may be employed in the present invention. For example, the communication medium may include telephone networks, wireless data transmission systems, two-way cable systems, customized computer networks, interactive kiosk networks, automatic teller machine networks, and the like.

With use of the Internet, a user may utilize a computer, which is a device user to interact with the communication medium. In one embodiment, the conventional general purpose computer using one or more microprocessors, such as, for example, a Pentium processor, a Pentium II processor, a Pentium Pro processor, an xx86 processor, an 8051 processor, a MIPS processor, a Power PC processor, or an Alpha processor. In one embodiment, the user computer runs an appropriate operating system, such as, for example, Microsoft® Windows® 3.×, Microsoft® Windows 98, Microsoft® Windows® NT, Microsoft® Windows® CE, Palm Pilot OS, Apple® MacOS®, Disk Operating System (DOS), UNIX, Linux®, or IBM® OS/2® operating systems. In one embodiment, the user computer is equipped with a conventional modem or other network connectivity such as, for example, Ethernet (IEEE 802.3), Token Ring (IEEE 802.5), Fiber Distributed Datalink Interface (FDDI), or Asynchronous Transfer Mode (ATM). As is conventional, in one embodiment, the operating system includes a TCP/IP stack which handles all incoming and outgoing message traffic passed over the communication medium.

In other embodiments, the user computer may, for example, be a computer workstation, a local area network of individual computers, an interactive television, an interactive kiosk, a personal digital assistant, an interactive wireless communications device, a handheld computer, a telephone, a router, a satellite, a smart card, an embedded computing device, or the like which can interact with the communication medium. While in such systems, the operating systems will differ, they will continue to provide the appropriate communications protocols needed to establish communication links with the communication medium.

FIG. 3B depicts a remote control 500 for use in the preferred embodiment as a remote control module 310. This remote control 500 allows a user to tilt up or down or to any angle all louvered panels, a single louver panel or any defined group or groups of louvered panels. For example, to tilt all louvered panels up, a user would press the button in the “ALL” box directly underneath the “TILT UP” heading.

FIG. 3C illustrates examples of varieties of groupings that can be used. For example, louvered panels 1-6 can all be individually controlled by use of the remote control 500. With continuing reference to FIG. 3C, louvered panels 1, 2 and 3 belong to group 7; louvered panels 4, 5, and 6 belong to group 8; louvered panels 1 and 4 belong to group 9; louvered panel 2 and 5 belong to group 11; louvered panel 3 and 6 belong to group 12. Each of these groups of louvered panels can also be controlled by the remote control 500 such that all their louvers are synchronously rotated to any desired position. For example, group 7 can be set to 90° (“OPEN”), while group 8 is set to 135° (“¾ OPEN”).

Now with respect to FIGS. 3B and 3C, the use of remote control 500 will be illustrated. For example, to tilt down a particular louvered panel indicated by number “6” (in FIG. 3C), a user would depress the button 510 adjacent the label “6” below the “TILT DOWN” heading. Once the desired tilt position is achieved, the user would depress the stop button 520. The remote control 500 could also be designed so that the rotation of a louvered panel only occurs as long as the button which identifies that louvered panel is depressed.

To tilt up all the louvered panels associated with remote control 500, a used would depress button 530, which is labeled “ALL” and below the “TILT UP” heading. Once the desired tilt position is achieved, the user would depress the stop button 520. Likewise, to tilt down all the louvered panels associated with remote control 500, a user would depress button 580, which is labeled “ALL” and below the “TILT DOWN” heading. Once the desired tilt position is achieved, the user would depress the stop button 520. Alternatively, the remote control 500 can be designed so that when button 530 is depressed, all of the louvered panels associated with the remote control 500 go to a preset position. Alternatively, the remote control 500 can be designed so that when button 530 is depressed, all of the louvered panels associated with the remote control 500 rotate in the desired direction as long as the button 530 is depressed.

For positioning all the louvered panels associated with group 11 (from FIG. 3C), which are louvered panels 2 and 5, to a ¾ open position (135 degrees), a user would first depress the “¾ OPEN” button 570 to indicate what position is desired. Next a user has to indicate what louvered panel or group of louvered panels is desired to position. In this example, to indicated group 11, first, the shift button 540, located by the “SHIFT” label above the “110-20” label is depressed. Actuation of the shift button 540 indicates to the remote control 500 that the 11-20 louvered panels or group of louvered panels are selected for movement. After the shift button 540 is depressed, a user would press either of the two buttons 550, 560, which identify that group 11 of louvered panels is to be moved. Once that operation occurs, the remote control 500 sends the appropriate signals to the system control module 300. If a 45 degree (¼ open) position is desired, a user would instead first depress the “¼ OPEN” button 590 in place of the “¾ OPEN” button 570.

The arrangement and design of the remote control 500 can be modified. For example, the remote control 500 can include a touch screen or LCD display. Additionally, the remote control can be designed without shift keys, with different labels, or with fewer buttons. Alternatively, the remote control 500 can incorporate a timer to be used to set the rotation of the louvers. In another embodiment, the remote control 500 includes a mouse and a display.

Thus, a user could use remote control 500 to designate a group of louvered panels to position. With the ability to control the mechanical opening and closing of a louvered panel, a system that controls a group of louvered panels can be arranged. In such an arrangement of multiple louvered panels, the opening and closing of any of the louvered panels can be coordinated. For example, louvered panels on one side of a house can be grouped together to be opened and closed synchronously while louvered panels on another side of a house can be opened and closed in a different synchronous pattern.

With reference to FIG. 3A, the system control module 300 is capable of communications with several louvered panels 330, 340, 350, and specifically with the motor control systems within those louvered panels. The communication medium between the system control module 300 and the several louvered panels 330, 340, 350 may be via wire links 331, 341, 351. As described above, this communication medium may also be cellular, wireless or infrared.

The system control module 300 can receive information from the remote control module 310 indicating the desired position of any louvered panel 330, 340, 350 to which the system control module 300 is connected. After the information is received by the louvered panel 330, 340, 350 of the desired position, the motor systems are directed to perform the actions necessary to reach the desired positions. Once the motor control module of a louvered panel receives the instructions from the system control module 300, the motor control module processes that information and then directs the performance of the motor system.

In another embodiment, the system control module 300 can receive information from a sun sensor (such as one available from Solar Shading Systems (Newport Beach, Calif.) or Electronic Solutions, Inc. (Broomfield, Colo.)) or a timer (such as one available from Solar Shading Systems (Newport Beach, Calif.) or Electronic Solutions, Inc. (Broomfield, Colo.)) or a temperature sensor. Alternatively, garage door sensors, motion sensors, occupancy sensors, astronomical clock and ambient light sensors could be used with the system control module 300. Other such environmental or automatic sensors could be used to provide the system control module with data as is known in the art.

The system control module 300 can also be designed to collect information from the motor control module of a louvered panel. For example, a motor control module can be configured to receive sensor inputs from sensors. Such sensor information, includes, but is not limited to, the amount of light passing through its louvered panel or window security status. Other types of information from motor control module sensors can be used as is known in the art.

FIG. 4 depicts the louver pin mechanism 100, adapted to be housed within a portion of the frame 105 of the louvered panel. A similar mechanism is described in U.S. Pat. No. 5,216,837 (issued Jun. 8, 1993) to Cleaver et al., which is incorporated herein by reference in its entirety. The louver pin mechanism 100 of FIG. 4 is essentially a cutaway portion of the louver pin mechanism 40 of FIG. 2, but in greater detail. The louver pin mechanism 100 includes gear racks 110, 115 which mesh with a plurality of pinion gears 120. This interaction between the pinion gears 120 and the gear racks 110, 115 allows for a rotation of one pinion gear 120 to cause racks 110, 115 to translate in opposite directions. Each louver 20 has a louver pin mechanism associated with it.

Also, movement of the racks 110, 115 in opposite directions translates into rotation of the pinion gear 120, which results in the pin 30 rotating. The rotation of pin 30 translates into rotation of louver 20. In this manner, a person moving a louver 20 will rotate pin 30 which will result in the rotation of pinion gear 120, which will result in movement of the racks 110, 115. Thus, when any one of the louvers 20 are rotated, all the louvers rotate synchronously.

The motor pinion 125 (of FIG. 2) meshes with the racks 110, 115 near the bottom or top of the louvered panel 10. Thus, movement of the motor pinion 125 translates into movement of the racks 110, 115 in opposite directions, which as described above, will result in the rotation of the louvers 20.

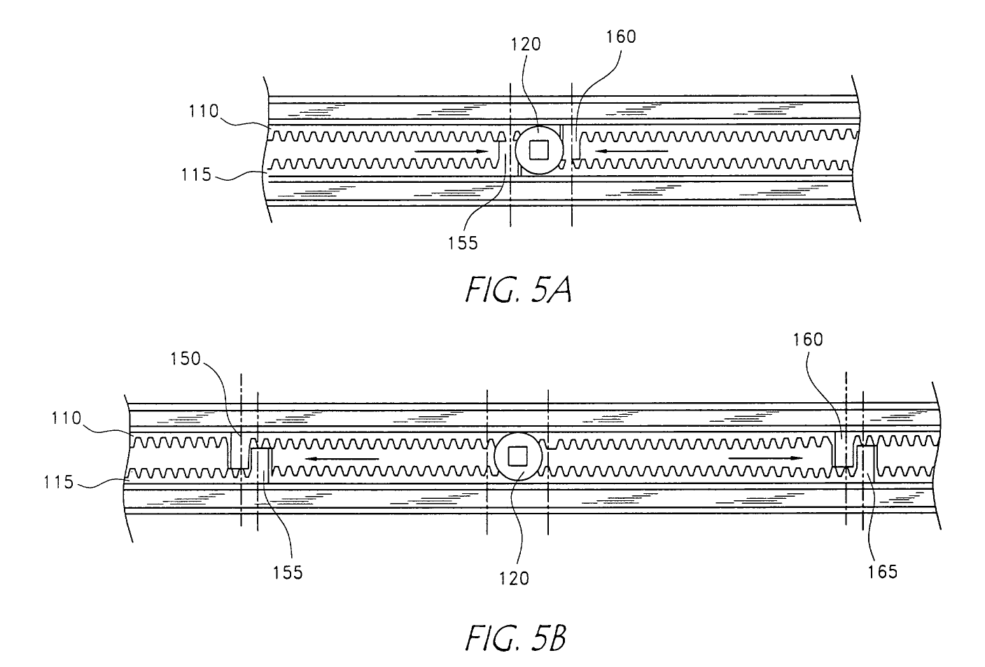

FIGS. 4, 5A and 5B depict the pinion gear 120 meshing with the racks 115, 110. Rack 115 includes stops 155 and 165. The stops 155 and 165 prevent movement of the rack 115, when either stop 155, 165 abuts the pinion gear 120. Subsequently, pinion gear 120 will be prevented from any further rotation and therefore louver 20 will be prevented from further rotation. Likewise, rack 110 includes stops 150 and 160. The stops 150 and 160 can prevent movement of the rack 115 and subsequently stop movement of pinion gear 120 and therefore stop movement of louver 20 in a similar manner.

With reference to FIG. 5A, stop 160 of rack 10 and stop 155 of rack 115 have converged on pinion 120 due to motion of rack 115 downward and movement of rack 110 upward. In this position, the louver 20 associated with this pinion 120 would be in a 0 degree position (fully down).

In FIG. 5B, stops 150 and 155 abut each other and prevent further rotation of the pinion 120. Likewise, stops 160 and 165 abut each other and prevent further rotation of the pinion 120. In this position, the louver 20 associated with this pinion 120 would be in a 180 degree position (fully up). The travel of the stops 150, 155, 160 and 165 (and of the associated racks 110, 115 and pinion 120 between the positions depicted in FIG. 5A to the positions depicted in FIG. 5B represents movement of a louver 20 from a 0 degree position to a 180 degree position. As one of skill in the art will recognize, any position between these to extremes will result in a partially open louver.

Those skilled in the art will recognize that a variety of rack and pinion systems could be used in this embodiment of the present invention.

With reference to FIGS. 2, 4, 5A and 5B, a louver panel 10 includes a louver drive mechanism 35 and louver pin mechanism 40. The louver drive mechanism 35 includes a motor system 45 and a motor pinion 125 for receiving and meshing with racks 110, 115 (not shown in FIG. 2, but described above). The motor system 45 and the motor control module 55 move motor pinion 125 such that racks 110 and 115 move up and down and thereby rotate pinion 120. As such, the motor system 45 and the motor control module 55 controls the angle at which the louver 20 is positioned.

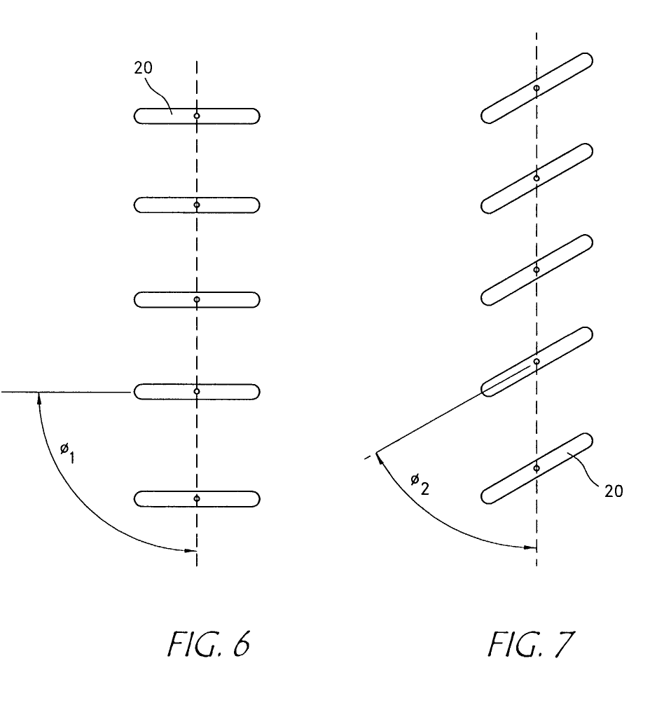

With reference to FIGS. 6 and 7, the louvers can be synchronously opened and closed or left partially open at any angle. For example, as shown in FIG. 6, the louvers 20 are all positioned at φ₁=90°. Likewise in FIG. 7, the louvers 20 are all positioned at φ₂=60°.

Now the operation of the motor will be described. The motor system 35 can be utilized with or without an encoder. An encoder is a type of feedback device which converts mechanical motion into electrical signals to indicate the position of the actuator. Typical encoders are designed with a printed disk and a light source. Other types of encoders use magnets and Hall effect sensors. Alternatively, an absolute position encoder can be utilized with the motor system 35. As the disk turns with the actuator shaft, the light source shines through the printed pattern onto the sensor. The light transmitted is interrupted by the patterns on the disk. These interruptions are sensed and converted to electrical signals. By analyzing the signals (and their transitions), actuator shaft position is determined.

For a louver drive mechanism 35 using a motor system 45 to position the louver 20 at a desired angle, the following procedure can be followed. First, the motor system 45 receives information from the motor control module 55, which has in turn received information from a system control module regarding what position is desired for the louvers. Then, the motor control module 55 instructs the motor system 45 to rotate until motor system 45 stalls. The motor system 45 will stall when the louvers can no longer rotate and the load seen by the motor system 45 increases. Generally, motor system 45 draws current depending on the load its pulling. Usually an increased load translates to an increased draw of current. Motor system 45 has a stall current, which is the current the motor system 45 draws when the motor system 45 is stopped by an opposing force. This stall current is much greater than the running current, or current that the motor system 45 draws under no load. The power supply (not shown) for the motor system 45 should be designed to handle the stall current with extra amperage to spare. The motor control module 55 monitors the current that the motor system 45 is drawing from the power supply. Each covered panel can have its own power supply, or there can be one power supply for all the louvered panels. When the current drawn by the motor system 45 is above a configurable (user-specified) threshold (predetermined to indicate a stall), the motor control module 55 sets a flag in its circuitry to indicate that event.

As described above, the stall occurs when the louvers 20 are in the 0 degree position or the 180 degree position. To have the same stall condition, the motor control system 55 should inform the motor system to rotate in the same direction (for instance, clockwise) so that the same stall condition is always achieved. This can be chosen to either be the 0 degree of 180 degree position. For this example, the 0 degree position will designate when the motor system 45 stalls after rotating clockwise (until the stops are abutting the pinion). This 0 degree position is referred to as the initial position. One could also choose the 180 degree position to be the initial position. Also, if an obstruction, such as a hand, prevents the louver from reaching the initial position, the motor system can be programmed to designate this new position as the initial position and recalibrate its movements accordingly.

Once the motor system 45 stalls, the motor control module 55 detects that stall condition. At this point, the motor control system knows that the louvers are in the initial position.

From the initial position, the louvers 20 are rotated to the desired location by the motor system 45. The motor system 45 can rotate the louvers 20 by being “on” (either clockwise or counter-clockwise) for a preset amount of time. Essentially, the motor control system 55 can be programmed with a lookup table to determine the amount of time to operate the motor system 45 to achieve a certain position of the louvers 20 from the initial position. Once the new position of the louvers is achieved, the motor system 45 is turned “off.” To move the louvers 20 to another desired position, the same routine is followed.

Alternatively, the louver drive mechanism 35 can use an encoder on the motor system 45 to count signal transitions which correspond to angles through which the louver is rotating. To detect that the motor system 45 has stalled, the motor control module 55 detects the absence of signal transitions from an encoder during louver rotation. At this point, the motor control system knows that the louvers are in the initial position. Then, if a position of 180 degrees equals a count of 2400 signal transitions from an encoder from the initial position, to achieve a louver position of 90° (“OPEN”), the motor system 45 must be “on” for a count of 1200 signal transitions from the encoder to be counted by the motor control system 55. Once the motor control system 55 counts 1200 signal transitions, the motor system 45 is turned “off” and the motor control system 55 knows exactly where the louvers 20 are positioned.

With an encoder, the motor control system 55 can keep track of where the louvers 20 are positioned. As such, if it is desired to move the louvers 20 from a 90 degree position to a 180 degree position, the motor control system 55 must keep the motor system 45 “on” in one direction for 1200 counts from the encoder. To move the louvers back to the 90 degree position, the motor control system 55 must keep the motor system 45 “on” in reverse for 1200 counts from the encoder.

In either system, the louvers 20 may encounter “backlash.” Backlash refers to the situation where a louver 20 rotates short of its desired location by some angle θ. Ordinarily, backlash occurs when a louver 20 is rotating from the 180° position down to a non-0° degree position. Thus, if a louver 20 were to be moved from the 180 ° position to the 90° position, because of backlash, the louver 20 may stop its travel at the 95° position. The motor system 45, however, would determine that the louvers 20 were at the 90° position. In this case the backlash would be 5°. Backlash occurs due to “slop” in the system between the motor system 45, the rack 115, 110 and pinion gear 120. This “slop” results in the rotation of the motor system 45, but of no corresponding rotation of the louvers 20. In the example above, the motor system 45 had to rotate through 5° of “backlash” before movement of the louvers 20 occurred, resulting in the louvers stopping short 5° of its target position. To correct for backlash, a skilled artisan observes the typical amount of backlash, θ₁°, in a louvered panel and programs the motor system 45 to compensate for that backlash. The backlash compensation is accomplished by rotating the louver 20 beyond the rotation required to get to the desired position plus the typical amount of backlash, θ₁°. Then, the motor system 45 rotates back to the desired position. This allows the “slop” that causes backlash to be rotated through; during the rotation through “backlash,” the motor system rotates but the louvers 20 do not rotate. Once the “backlash” has been rotated through, the louvers 20 begin movement.

In the example above, the motor system 45 is programmed to overshoot its target desired position by 10°. Thus, when the motor system 45 is directed to rotate the louvers 20 to 90°, the motor system 45 rotates the louvers 20 to the position it considers as 80°. Due to “backlash,” however, the motor system 45 has actually only rotated the louvers 20 to 85°. To compensate for this “backlash,” the motor system 45 then rotates the louvers 10° toward the desired 90° position. Here, the first 5° of rotation result in rotating through “backlash”—the motor system 45 is rotating, but the louvers 20 do not. The second 5° of rotation result in the movement of the louvers 20 from the 85° position to the 90° position. Alternatively, “backlash” could be compensated by using an encoder on the louvers 20 to send data regarding the louvers' 20 actual position to the motor system 45.

As it will be recognized by those of skill in the art, motors of different speeds can be used in the motor system 45 to achieve different speeds of louver motion. Also a single motor with variable speeds can be used.

It is to be understood that not necessarily all objects or advantages described above may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein. For example, different encoding techniques and transmission protocols for communications may achieve differing efficiencies.

Furthermore, the skilled artisan will recognize the interchangeability of various features from different embodiments. For instance, the motor system and motor control module may be a configured as a single unit; or the motor control module and the system control module may be a single module. In addition to the variations described herein, other known equivalents for each feature can be mixed and matched by one of ordinary skill in this art to construct systems to deliver customized context sensitive content to a user in accordance with principles of the present invention.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the breadth and scope of the present invention herein disclosed should not be limited by the particular disclosed embodiments described above, but should be determined only by a fair reading of the claims that follow.

What is claimed is:

1. An automatic louver actuating system, comprising:
a plurality of louvered panels, wherein each louvered panel comprises a plurality of louvers capable of rotational movement;
a plurality of motors, wherein each motor controls the rotational movement of a panel of louvers; and
a control module, wherein the control module is in communication with each motor.

2. The automatic louver actuating system of claim 1, wherein the motor includes an encoder.

3. The automatic louver actuating system of claim 1, wherein the communication is infrared.

4. The automatic louver actuating system of claim 1, wherein the communication is ultrasonic.

5. The automatic louver actuating system of claim 1, wherein the communication is radio waves.

6. An electronic louver actuating system, comprising
a plurality of frames, wherein each frame defines an interior region;
a plurality of slats rotatably disposed within each interior region of the plurality of frames;
a plurality of electronic actuating devices, wherein each electronic actuating device is capable of rotating the plurality of slats within each of the plurality of frames; and
a control module, wherein the control module is in communication with each electronic actuating device.

7. The automatic louver actuating system of claim 6, wherein the electronic actuating device includes an encoder.

8. The automatic louver actuating system of claim 6, wherein the communication medium is infrared.

9. The automatic louver actuating system of claim 6, wherein the communication medium is ultrasonic.

10. The automatic louver actuating system of claim 6, wherein the communication medium is radio waves.

11. A method of electronic louver actuating, comprising:
communicating to a first motor a first desired position for a first set of louvers in a first louvered panel;
communicating to a second motor a second desired position for a second set of louvers in a second louvered panel;
rotating the first set of louvers in the first louvered panel to the first desired position by the first motor;
rotating the second set of louvers in the second louvered panel to the second desired position by the second motor.

12. The method of claim 11, wherein the first motor uses an encoder.

13. The method of claim 11, wherein the second motor uses an encoder.

14. An automatic louver actuating system, comprising:
a first louvered panel, wherein the first louvered panel comprises a first plurality of louvers capable of rotational movement;
a second louvered panel, wherein the second louvered panel comprises a second plurality of louvers capable of rotational movement;
a first motor, wherein the first motor controls the rotational movement of the first plurality of louvers;
a second motor, wherein the second motor controls the rotational movement of the second plurality of louvers; and
a control module, wherein the control module communicates with the first and second motors.

15. The automatic louver actuating system of claim 14, wherein the communication medium is wireless.

16. A method of controlling a plurality of louvered panels, comprising,
selecting a louvered panel to rotate;
storing information representing the selected louvered panel;
selecting a desired rotation for the louvered panel;
storing information representing the selected desired rotation;
transmitting the information representing the selected desired rotation and the information representing the selected louvered panel over a wireless communication medium.

17. The method of claim 16, wherein the wireless communication medium is infrared.

18. The method of claim 16, wherein the wireless communication medium is ultrasonic.

19. The method of claim 16, wherein the wireless communication medium is radio.
